(19) United States
(12) Patent Application Publication
(10) Pub. No.: US 2025/0074611 A1
(43) Pub. Date: Mar. 6, 2025

(54) ASSEMBLY OF A LONGITUDINAL MEMBER OF A WING AND AN ENGINE PYLON WHICH ARE HORIZONTALLY ALIGNED RELATIVE TO ONE ANOTHER

(71) Applicant: Airbus Operations SAS, TOULOUSE (FR)

(72) Inventors: Pierre-Antoine COMBES, TOULOUSE (FR); Marc DE NICOLA, TOULOUSE (FR)

(21) Appl. No.: 18/819,000

(22) Filed: Aug. 29, 2024

(30) Foreign Application Priority Data
Aug. 31, 2023 (FR) 2309134

(51) Int. Cl. B64D 27/40

(52) U.S. Cl. CPC B64D 27/402

(57) ABSTRACT

An assembly comprising a longitudinal member of an aircraft wing, where the longitudinal member has a contact wall which is penetrated by first bores, each passing through the contact wall parallel to a longitudinal direction, an engine pylon which is arranged at the end of the longitudinal member in the longitudinal direction and having an upper longitudinal member which, for each first bore, is penetrated by a second bore which is aligned with the first bore, and a nut and a screw for each pair of a first bore and a second bore, which are aligned, where the screw is screwed into the nut successively via the first bore and the second bore, sandwiching the upper longitudinal member and the contact wall.

### CROSS-REFERENCES TO RELATED APPLICATIONS

This application claims the benefit of French Patent Application Number 2309134 filed on Aug. 31, 2023, the entire disclosure of which is incorporated herein by way of reference.

### FIELD OF THE INVENTION

The present invention relates to an assembly of a longitudinal member of an aircraft wing with an engine pylon which are horizontally aligned with one another and where the fixing is provided by horizontal screw-nut systems. The present invention also relates to an aircraft comprising such an assembly.

### BACKGROUND OF THE INVENTION

An aircraft conventionally comprises at least one engine, in particular a turbojet engine. The aircraft comprises an engine pylon below each wing and for each engine, said engine pylon being fixed to the structure of the wing and the engine being suspended below the engine pylon.

Conventionally, the engine pylon is arranged below the wing and is fixed thereto by various fixing means.

In order to gain efficiency, engines are becoming increasingly large and the positioning of the engine pylon below the wing limits the possibilities for increasing the size, since the engine has to maintain a minimum distance relative to the ground.

It is thus desirable to find a novel arrangement which makes it possible to gain space in the region of the joint between the engine pylon and the wing, in order to lift up the engine.

### SUMMARY OF THE INVENTION

A subject of the present invention is to propose an assembly of a longitudinal member of an aircraft wing with an engine pylon which provides a reduction in the height of the assembly. To this end, an assembly for an aircraft comprising a wing is proposed, said assembly comprising:

a longitudinal member of the wing, where the longitudinal member has a contact wall which is penetrated by a plurality of first bores, each passing through the contact wall and parallel to a longitudinal direction perpendicular to the contact wall,

an engine pylon which is arranged at the end of the longitudinal member in the longitudinal direction and having an upper longitudinal member which is generally perpendicular to the contact wall and which is penetrated, for each first bore, by a second bore which is parallel to the longitudinal direction and aligned with the first bore, and

a nut and a screw for each pair of a first bore and a second bore which are aligned, where the screw is screwed into the nut successively via the first bore and the second bore, sandwiching the upper longitudinal member and the contact wall.

Such an assembly makes it possible to reduce the height of the assembly and the horizontal orientation of the screw-nut systems ensures that it works only under tension.

Advantageously, the engine pylon comprises a lateral wall on either side of the upper longitudinal member, and the assembly comprises two shear pins, one thereof being inserted into a first hole of the contact wall and a second hole of a lateral wall, and the other thereof being inserted into a first hole of the contact wall and a second hole of the other lateral wall.

Advantageously, the shear pins are mounted so as to be tightened in the corresponding holes and the screws are mounted with clearance in the corresponding bores.

Advantageously, the assembly comprises an intermediate wall which is arranged between the contact wall and the upper longitudinal member and, for each screw, the intermediate wall is passed through by an intermediate bore which is passed through by the screw and, when shear pins are present, for each shear pin the intermediate wall is passed through by an intermediate hole which is passed through by the shear pin.

Advantageously, the upper longitudinal member is penetrated by at least one third bore which is perpendicular to the longitudinal direction in which the second bore opens out, and the nut is a barrel nut housed in the third bore.

The invention further proposes an aircraft comprising a wing and an assembly according to one of the preceding variants.

### BRIEF DESCRIPTION OF THE DRAWINGS

The features of the invention which are mentioned above, in addition to others, will become more apparent from reading the following description of an exemplary embodiment, said description being made in relation to the accompanying drawings, in which:

FIG. 1 is a side view of an aircraft according to the invention,

FIG. 2 is a perspective view of an assembly according to a first embodiment of the invention,

FIG. 3 is a perspective view of an assembly according to a second embodiment of the invention,

FIG. 4 is a sectional view along the plane IV of the assembly of FIG. 3, and

FIG. 5 is a front view of a longitudinal member of a wing of an assembly according to the invention without the engine pylon.

### DETAILED DESCRIPTION OF THE PREFERRED EMBODIMENTS

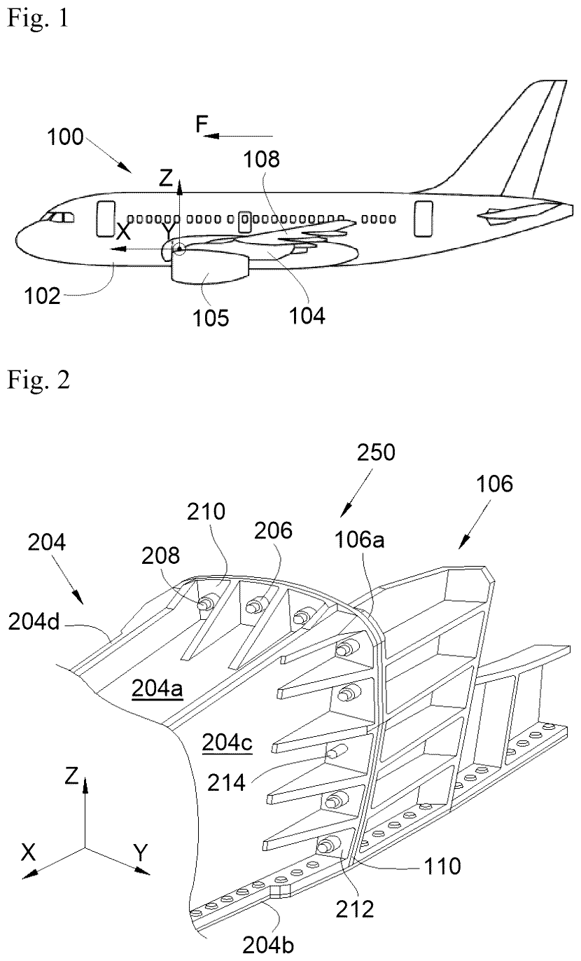

In the following description, terms which relate to a position are taken to refer to an aircraft in the position of forward travel, i.e. as shown in FIG. 1 where the arrow F represents the direction of forward travel.

FIG. 1 shows an aircraft 100 which has a fuselage 102, a wing 108 being arranged on either side thereof and an engine 105, in particular a turbojet engine, being fixed there below by means of a engine pylon 104 which in turn is fixed to the wing 108.

In the following description and for the sake of convention, X refers to the longitudinal direction of the engine pylon 104 oriented positively in the direction of forward travel of the aircraft 100 and generally parallel to the longitudinal axis of the aircraft 100, Y refers to the transverse direction of the engine pylon 104 which is horizontal when the aircraft 100 is on the ground, and Z refers to the vertical direction or vertical height when the aircraft 100 is on the ground, these three directions X, Y and Z being at right-angles to one another.

In the embodiment of the invention shown in FIG. 1, the aircraft 100 comprises an engine 105 below each wing 108 of the aircraft 100, but it is possible to provide a plurality of engines 105 below each wing 108.

The wing 108 comprises, amongst other things, longitudinal members 106 which extend parallel to the longitudinal direction X. The longitudinal member 106 of the wing 108 has a contact wall 106a which extends in a plane generally perpendicular to the longitudinal direction X.

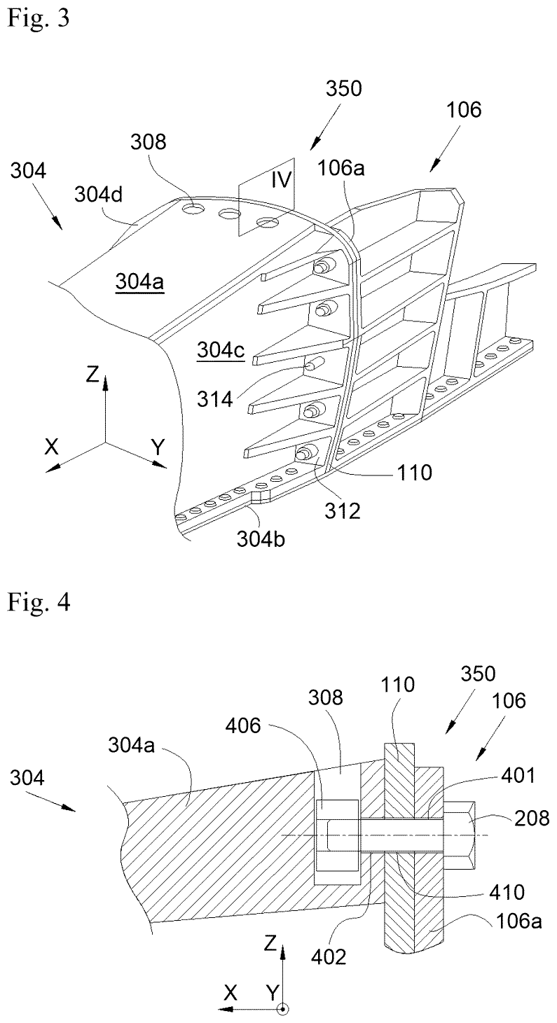

FIG. 2 shows a first embodiment of an assembly 250 between a longitudinal member 106 of the wing 108 and the engine pylon 204 and FIGS. 3 and 4 show a second embodiment of an assembly 350 between a longitudinal member 106 of the wing 108 and the engine pylon 304. The difference between the first embodiment and the second embodiment is in the shape of the upper longitudinal member 204a, 304a of the engine pylon 204, 304 and the fixing thereof to the longitudinal member 106 of the wing 108.

The engine pylon 204, 304 takes the form of a box which in this case comprises an upper longitudinal member 204a, 304a, a lower longitudinal member 204b, 304b and two lateral walls 204c-d, 304c-d. The various walls and the longitudinal members are fixed to one another so as to form a box, the vertical section thereof being generally trapezoidal. Each longitudinal member 204a-b, 304a-b and each lateral wall 204c-d, 304c-d extend in a plane which is generally parallel to the longitudinal direction X, i.e. generally perpendicular to the contact wall 106a. The engine pylon 204, 304 is generally symmetrical relative to a vertical median plane XZ.

The lateral walls 204c-d, 304c-d are arranged on either side of the upper longitudinal member 204a, 304a.

The contact wall 106a is penetrated by a plurality of first bores 401 where each bore passes through the contact wall 106a and is parallel to the longitudinal direction X, i.e. perpendicular to the contact wall 106a.

The engine pylon 204, 304 is arranged at the end of the longitudinal member 106 of the wing 108, in the longitudinal direction X, i.e. in the extension of one another in the longitudinal direction X. The engine pylon 204, 304 thus extends the longitudinal member 106 of the wing 108 in the longitudinal direction X.

For each first bore 401, the upper longitudinal member 204a, 304a is penetrated by a second bore 402 which is also parallel to the longitudinal direction X and aligned with the first bore 401 in the assembled position.

In the first embodiment of the invention, the second bore 402 is produced in an angle piece 210 of the upper longitudinal member 204a, where the angle piece 210 is parallel to the contact wall 106a.

In the second embodiment of the invention, the second bore 402 is produced from a third bore 308 which is produced in the upper longitudinal member 304a perpendicular to the longitudinal direction X. The second bore 402 thus opens out into the third bore 308.

The third bore 308 opens out in the region of an upper face of the upper longitudinal member 304a and is preferably blind.

In the same manner, the lateral walls 204c-d, 304c-d comprise angle pieces 212, 312 which are parallel to the contact wall 106a and which are also passed through by second bores aligned with first bores of the contact wall 106a parallel to the longitudinal direction X.

The fixing of the engine pylon 204, 304 to the longitudinal member 106 of the wing 108 is provided by screw-nut systems. Thus the assembly 250, 350 comprises a nut 206, 406 and a screw 208 for each pair of a first bore 401 and a second bore 402 which are aligned. The screw 208 is screwed into the nut 206, 406 successively through the first bore 401 of the contact wall 106a and the second bore 402 of the upper longitudinal member 204a, 304a, sandwiching the upper longitudinal member 204a, 304a and the contact wall 106a between the head of the screw 208 and the nut 206, 406.

With such an arrangement, the height of the assembly is reduced due to the alignment of the longitudinal member 106 of the wing 108 and of the engine pylon 204, 304 and due to its orientation parallel to the longitudinal direction X, and each screw-nut system works solely in tension, taking up the axial forces in the longitudinal direction X, such as thrust. The joint between the engine pylon 204, 304 and the longitudinal member 106 of the wing 108 is thus implemented on a single interface plane, i.e. the plane of the contact wall 106a where the screw-nut systems are arranged so as to transmit the forces generated by the engine 105 to the wing 108, while guaranteeing that the joint does not separate.

In the embodiments of the invention shown in FIGS. 2 and 3, the assembly 250, 350 also comprises a shear pin 214, 314 which is arranged symmetrically on either side of the vertical median plane XZ and thus on each side of the upper longitudinal member 204a, 304a. Thus a shear pin 214, 314 is present on the port side and a shear pin is present on the starboard side. Each shear pin 214, 314 is also parallel to the longitudinal direction X.

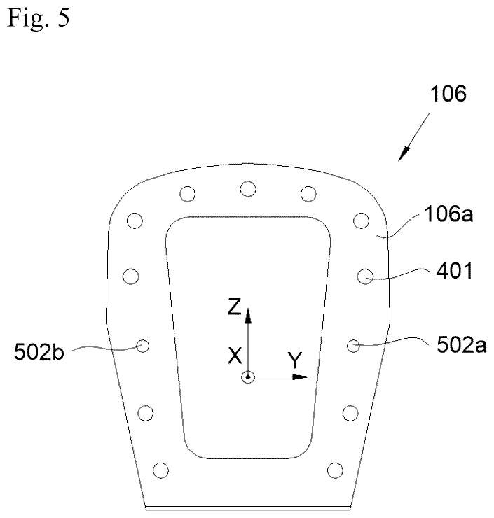

FIG. 5 shows the longitudinal member 106 of the wing 108 and more particularly the contact wall 106a. In this embodiment, there are eleven screw-nut systems with three in the region of the upper longitudinal member 204a, 304a and four for each lateral wall 204c-d, 304c-d. Each shear pin 214, 314 is inserted into a first hole 502a-b of the contact wall 106a, namely a first hole 502a on the port side and a first hole 502b on the starboard side, and a second hole of a lateral wall 204c-d, 304c-d of the engine pylon 204, 304, here in an angle piece 212, 312 of the lateral wall 204c-d, 304c-d under consideration. The first hole 502a-b and the second hole which are associated with one another are aligned in the assembled position. The first holes 502a-b and the second holes are arranged on either side of the vertical median plane XZ.

Thus one shear pin 214, 314 is inserted into a first hole 502a of the contact wall 106a and a second hole of a lateral wall 204c-d, 304c-d and a further shear pin 214, 314 is inserted into a first hole 502b of the contact wall 106a and a second hole of the other lateral wall 204d-c, 304d-c.

The shear pins 214, 314 take up the shear forces and the engine torque and are mounted so as to be tightened in the corresponding holes, while the screws 208 are mounted with clearance in the corresponding bores, including the intermediate hole and the intermediate bore 410 described below.

With such an arrangement, in the case of the rupture of a screw-nut system, the other screw-nut systems compensate therefor and ensure the transfer of axial forces, and in the case of the rupture of a shear pin 214, 314, the longitudinal member 106 of the wing 108 and the engine pylon 204, 304 can pivot about the other shear pin 314, 214 and the rotation is stopped by the screw-nut systems which thus transmit the axial forces as well as the shear forces and the engine torque.

In the embodiments of the invention shown in FIGS. 2 and 3, the assembly 250, 350 also comprises an intermediate wall 110 which is arranged between the contact wall 106a and the upper longitudinal member 204a, 304a.

For each screw 208, the intermediate wall 110 is passed through by an intermediate bore 410 which the screw 208 passes through.

When shear pins 214, 314 are present, for each one thereof, the intermediate wall 110 is passed through by an intermediate hole which the shear pin 214, 314 passes through. In the embodiment of the invention shown in FIG. 3 and in FIG. 4, the nut 406 is a barrel nut which is housed in the third bore 308 in order to block the nut in rotation when the screw 208 is tightened.

With this particular arrangement, the thickness of the upper longitudinal member 304a is increased since there is no need to provide space for the angle pieces 210, which makes it possible to optimize the inertia of the engine pylon 304 in order to be able to pass larger forces into the engine pylon 304.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly for an aircraft comprising a wing, said assembly comprising:
a longitudinal member of a wing, wherein the longitudinal member has a contact wall which is penetrated by a plurality of first bores, each passing through the contact wall and parallel to a longitudinal direction perpendicular to the contact wall,
an engine pylon arranged at an end of the longitudinal member in the longitudinal direction and having an upper longitudinal member which is generally perpendicular to the contact wall and which, for each first bore, is penetrated by a second bore which is parallel to the longitudinal direction and aligned with the first bore, and
a nut and a screw for each pair of a first bore and a second bore which are aligned, wherein the screw is screwed into the nut successively via the first bore and the second bore, sandwiching the upper longitudinal member and the contact wall.

2. The assembly according to claim 1, wherein the engine pylon comprises a lateral wall on either side of the upper longitudinal member and wherein the assembly comprises two shear pins, one thereof being inserted into a first hole of the contact wall and a second hole of a lateral wall, and the other thereof being inserted into a first hole of the contact wall and a second hole of the other lateral wall.

3. The assembly according to claim 2, wherein the shear pins are mounted so as to be tightened in the corresponding holes and the screws are mounted with clearance in the corresponding bores.

4. The assembly according to claim 1, further comprising:
an intermediate wall arranged between the contact wall and the upper longitudinal member,
wherein, for each screw, the intermediate wall is passed through by an intermediate bore which is passed through by the screw and,
wherein, when shear pins are present, for each shear pin the intermediate wall is passed through by an intermediate hole which is passed through by the shear pin.

5. The assembly according to claim 1, wherein the upper longitudinal member is penetrated by at least one third bore which is perpendicular to the longitudinal direction in which the second bore opens out, and
wherein the nut is a barrel nut housed in the third bore.

6. An aircraft comprising:
a wing and
the assembly according to claim 1.
